(19) United States
(12) Patent Application Publication
(10) Pub. No.: US 2002/0097978 A1
(43) Pub. Date: Jul. 25, 2002

(54) Architectural display and lighting system with interactive capability

(75) Inventors: Brian C. Lowry, Emlenton, PA (US); Evan Wimer, Pittsburgh, PA (US)

Correspondence Address: PEPPER HAMILTON LLP, 50th Floor, One Mellon Center, Pittsburgh, PA, 15219, US

(73) Assignee: Transvision, Inc.

(21) Appl. No.: 10/051,491

(22) Filed: Jan. 18, 2002

Related U.S. Application Data
(60) Provisional application No. 60/263,121, filed on Jan. 19, 2001.

(51) Int. Cl. G02B 6/00; G02B 6/04

(52) U.S. Cl. 385/147; 385/115; 385/901

(57) ABSTRACT

A suite of fiber optic display panels is configured and connected into multi-panel arrays to provide lighting and/or image displays from floors, walls, ceilings or other architectural settings. One or more projectors launch images onto an optical fiber input matrix, which apportions and transfers the images into an ordered array of display optical fibers. The display optical fibers are arranged in an ordered array on a display surface panel. The display optical fibers transfer segmented input images to the display surface, where reconstituted and magnified images appear to the viewer. Additionally, the system can provide interactive features such as building directions, gaming environments, or security systems.

### CLAIM OF PRIORITY

This application claims priority to U.S. Provisional Application No. 60/263,121, filed Jan. 19, 2001, which is incorporated herein by reference in its entirety.

### FIELD OF THE INVENTION

This application relates to large screen display devices. In particular, this application relates to interactive display systems having a size and shape to match the contour of an environment.

### BACKGROUND OF THE INVENTION

A large screen display (“LSD”) may be defined as any dynamic display that is sufficiently large to be viewed by a group of people at some distance from the display. The LSD market is diverse, with many differing products and technologies, each having certain strengths and weaknesses, competing to fill the needs of the end user. Applications requiring outdoor use in direct sunlight have traditionally been served best by cathode ray tube (“CRT”) and light-emitting diode (“LED”) displays, while indoor applications are served by video walls or front/rear projection systems. Fiber optic LSDs, however, offer substantial improvements over current CRT-and LED-based displays, due to their smaller depth, lighter weight, and elimination of sensitive and expensive electronic components on the surface of the display, while delivering superior resolution and adequate brightness for direct sunlight applications. Fiber optic LSDs are also superior to video walls because of the lack of mullions or divisions within the screen, improved brightness and color uniformity, more rugged design, thinner profile, and smaller footprint. Finally, fiber optic displays have many advantages over projection systems, including all the above advantages over video walls, as well as the fact that the display unit can be more easily moved and installed.

Although the presence of LSDs in public venues such as sports arenas has become quite common and even expected, many other possible venues have been overlooked. If the technology driving LSDs became more applicable to a variety of environments and, in addition, enabled for interaction with viewers and users of LSDs, the market could be expanded considerably. One of the untapped areas for both interactive and non-interactive LSDs is in architectural lighting and display within an enclosed space. Methods for providing architectural lighting displays within an enclosed space are well known: these include static lighting, dynamic lighting, and day lighting. The technology of fiber optic LSDs is opening entirely new approaches to architectural lighting techniques. By employing the architectural, dynamic display, and interactive characteristics of fiber optic LSD technology, considerable value can be added to the LSD market.

Currently, LSDs are located in places such as shopping malls, airports, and sports arenas. However, there are many other locations and environments in which LSDs could provide advertising, information, news, and/or entertainment, where it is not presently feasible to position an LSD due to technological limitations. Examples of such environments include partial or total submersion under water, extreme temperature conditions, and integration into architectural designs. Thus, there is a need for a way to place LSDs into locations and environments where current, state-of-the-art LSDs cannot fit or function.

The deployment of state-of-the-art LSDs is also presently restricted by environmental and power consumption considerations. Such LSDs include lighted static displays, liquid crystal displays (“LCDs”), LED displays, video walls, rear projection systems, and other display technologies. There are a number of areas and industries that would benefit significantly by a more robust LSD system. Introduction of LSDs to these markets could dramatically expand the demand for these devices. Thus, there is a need for LSDs that are lightweight, submersible, impact resistant, stable over a wide range of temperatures, and which consume a relatively small amount of power, generate little heat, or possess at least several of these features.

Present state-of-the-art fiber optic LSDs are stand-alone systems that are often mounted on walls, suspended from ceilings, or placed on floors. They serve the purpose of displaying information but are not capable of providing full-effect architectural display or virtual reality gaming environments. Fiber optic displays integrated into architectural structures could provide entirely new environments for the viewer that might be used for purposes of training, security, entertainment, or mood lighting. If it were possible to easily integrate this type of display into existing standardized architectural structures of various sizes, new and existing construction could provide an extremely large market for LSDs. There is a need for a way to integrate fiber optic displays into standard architectural panel sizes.

Because of limitations in state-of-the-art LSD technology, namely, the need for the viewer to be disposed at least several meters away from the display surface, interactive technology has never been integrated with LSD technology. Moreover, because of the fragile surface-mount components and fabrication processes used for state-of-the-art displays (LEDs, for example), they are not suitable for direct human contact. Fiber optic LSDs, however, can be inexpensively fabricated with additional optical components for sensing the absence or presence of light, while providing a robust display surface that is suitable for direct human contact. Thus, there is a need for a way to integrate interactive features into LSDs.

### SUMMARY OF THE INVENTION

In accordance with a preferred embodiment of this invention, an architectural display apparatus comprises a plurality of display panels. Each panel includes a display surface and an array of display optical fibers, The apparatus also includes a projector capable of projecting one or more images and an input matrix. The input matrix is optically connected to each array of display optical fibers, and it is positioned such that the input matrix receives an image from the projector, apportions the image into image segments, and distributes the apportioned image segments to the arrays of display optical fibers. The apparatus also includes a support structure that is sized and positioned to maintain the plurality of display panels in a contour and shape that matches a contour and shape of an existing environment.

Optionally, at least one of the display panels also includes a sensor array. In this embodiment, the sensor array may comprise an ultrasonic sensor, an infrared sensor, a light-sensitive transducer, and/or a motion detector.

Also optionally, the support structure may comprise a plurality of architectural mounts, and the architectural mounts may be structurally connected to the existing environment. Preferably, the display optical fibers are arranged in an ordered array.

### BRIEF DESCRIPTION OF THE DRAWINGS

FIG. 1 illustrates an exemplary fiber optic display panel system.

FIG. 2 illustrates a side view of a fiber optic display panel array.

FIG. 3 illustrates image segmentation and magnification on a fiber optic display panel array.

FIG. 4 illustrates a cross-section (side view) of a display room with integrated fiber optic display panels on floor, walls, and ceiling.

FIG. 5 illustrates how a pair of image projectors provides images to a 2×3 panel fiber optic display array.

FIG. 6 illustrates an input matrix.

FIG. 7 illustrates an exemplary set of six image projectors providing images to a 2×3 panel fiber optic display array.

FIG. 8 illustrates an exemplary set of micro-displays providing images to a 2×3 fiber optic display array.

### DETAILED DESCRIPTION OF PREFERRED EMBODIMENTS OF THE INVENTION

A preferred embodiment of the invention comprises a method and apparatus for providing architectural displays. The display may optionally be static, dynamic, non-interactive, and/or interactive with one or more viewers or users.

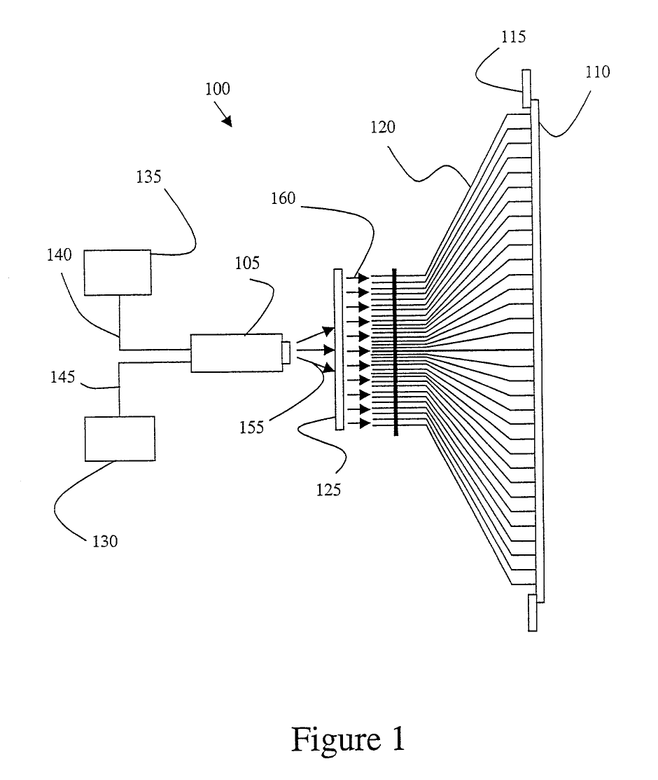

FIG. 1 illustrates an exemplary fiber optic display panel system 100. This system includes an image projector 105, a first light path 155, a second light path 160, an input matrix 125, an array of display optical fibers 120, a display surface 110, and mechanical mounting mechanism 115. System 100 further includes a power source 135, a power line connection 140, an image source 130, and an image feed line 145.

Image projector 105 is electrically connected to power source 135 by power line connection 140 and electrically connected to image source 130 by image feed line 145. Image projector 105 is optically connected to input matrix 125 by first light path 155 generated by image projector 105. Input matrix 125 is optically connected to display optical fibers 120 via second light path 160 through input matrix 125. Display optical fibers 120 are optically and mechanically connected to display surface 110.

In operation, image source 130 provides image content to image projector 105 via image feed line 145. The image content preferably consists of dynamic digital images, but alternatively it may consist of analog images and may be static rather than dynamic. The image projector 105 may be custom but is typically a commercial off-the-shelf video/data projector, optionally and preferably with a lens that allows for short focal distances. This type of projector typically employs 1-3 polysilicon thin film transistor (“TFT”) LCDs or digital micromirror displays (“DMDs”) as well as a short-arc high-intensity discharge lamp for illumination. Other numbers of TFT's and DMDs may be used. Power source 135 provides power to image projector 105 via power line connection 140. Image projector 105 optically projects the image content onto input matrix 125 via first light path 155. From input matrix 125 the image is apportioned into display optical fibers 120 via second light path 160. Through the mechanism of total internal reflection, display optical fibers 120 transmit the apportioned image to display surface 110 where display optical fibers 120 terminate. The end-points of display optical fibers 120 are arranged in an array of columns and rows on display surface 110, evenly distributed across display surface 110, and located so that the ends of the fibers are slightly recessed with respect to display surface 110. Image segments launched from this optical fiber array recombine in the space in front of display surface 110 to form a coherent magnified image as perceived by a viewer. This magnified image can be viewed from perspective points at some distance (>1 meter) from the screen. The number of display optical fibers 120 needed to achieve a coherent image for a given display surface is on the order of 25,000 fibers/m², but depends strongly on display surface size and resolution requirements, as well as the display application. Display fiber densities preferably in the range 5,000 to 500,000 fibers/m² will encompass most size, resolution, and display application requirements, although other densities are possible.

In one example, multiple display surfaces 110 may be optically interfaced and mechanically combined as arrays of display “tiles” to form larger display surfaces, as shown and described in commonly owned and assigned U.S. Utility Pat. No. 6,304,703 entitled “Tiled Fiber Optic Display Apparatus,” herein incorporated by reference in its entirety.

Display surface 110 may be made to any size. An example would measure two feet by two feet. Mechanical mounting mechanism 115 may be used to mount the display surface 110 to any structural framework or surface, including additional display surfaces. Display surface 110 may be mounted in any orientation and is typically fabricated from injection-molded thermoplastic, such as ABS, polycarbonate, or other material appropriate to the environmental conditions in which the display surface will be deployed. For additional protection from surface damage, display surface 110 may be covered with a thin transparent material such as acrylic, polycarbonate, or glass.

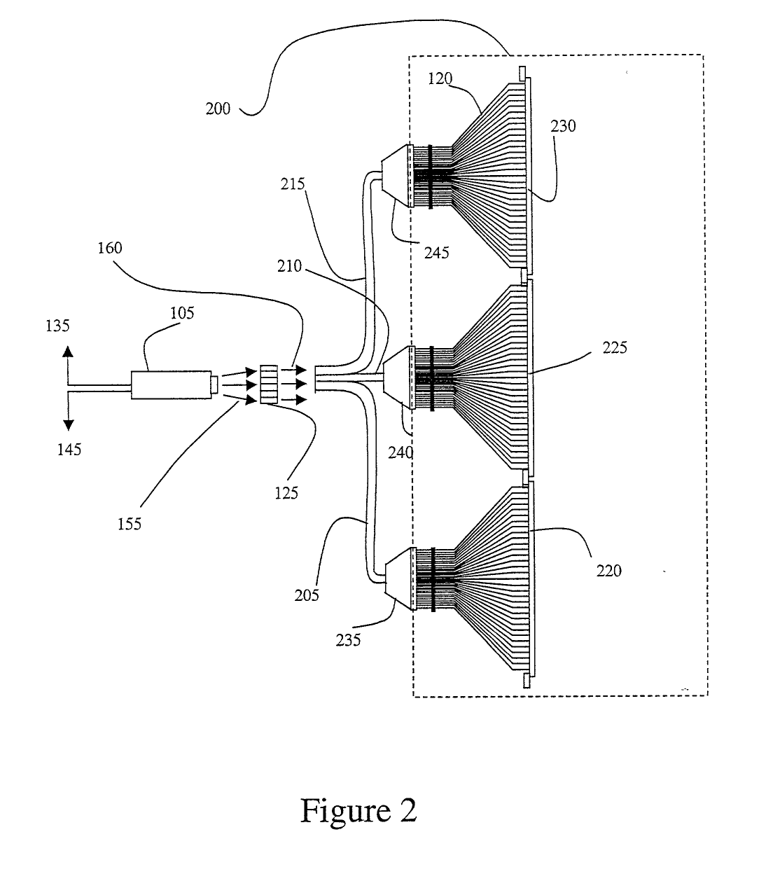

Refer to FIG. 2, a side view of a fiber optic display panel array 200. Array 200 includes image projector 105, input matrix 125, a first optical fiber bundle 205, a second optical fiber bundle 210, a third optical fiber bundle 215, a first display surface 220, a second display surface 225, and a third display surface 230.

As described in FIG. 1, image projector 105 is electrically connected to power source 135 by power line connection 140 and electrically connected to image source 130 by image feed line 145. Image projector 105 is optically connected to input matrix 125 by first light path 155 generated by image projector 105.

Referring to FIG. 2, input matrix 125 may be optically connected to first optical fiber bundle 205, second optical fiber bundle 210, and optionally a third optical fiber bundle 215 by second light path 160 through input matrix 125. Additional numbers of optical fiber bundles (in fact, any number) may be used. Optical fiber bundles 205, 210, and 215 are distributed within first fiber enclosure 235, second fiber enclosure 240, and third fiber enclosure 245, respectively, which provide packaging and protection for display optical fibers 120. Display optical fibers 120 are mechanically affixed to display surfaces 220, 225, and 230 using optical epoxy (e.g., EpoTek 301) or mechanical fiber carriers. U.S. patent application Ser. No. 09/718,745 commonly owned and assigned, entitled “A Large Screen Fiber Optic Display with High Fiber Density and Method for its Rapid Assembly,” further shows and describes the details associated with manufacturing the display panels which comprise this invention, and is herein incorporated by reference in its entirety.

In operation, individual display surfaces 220, 225, and 230 are mechanically connected and arranged into display array 200. Image projector 105 projects image content onto input matrix 125 from which it is apportioned into optical fiber bundles 205, 210, and 215 that encompass a large number of display optical fibers 120. Display optical fibers 120 are distributed within fiber enclosures 235, 240, and 245 and affixed to and terminated at display surfaces 220, 225, and 230 respectively. The apportioned image is conveyed through display optical fibers 120 to display surfaces 220, 225, and 230 where a coherent and magnified image is reconstituted on each display panel in display array 200. Additional display panels may be added to display array 200 to achieve any desired image size or to display multiple images.

Multiple fiber optic display panel arrays 200 can be integrated into existing architectural structures, including suspended ceilings, raised flooring, and wall structures. Also, one or more fiber optic display panel arrays can serve as structures themselves—as wall partitions, flooring, or ceiling tiles.

There is no practical limit to the number of display surfaces that may be combined to form fiber optic display panel array 200. The approximate preferred number of image projectors needed to provide a visible image on a given display array is one image projector for every 1-3 m² of display surface, depending on the light output of the projectors (total lumens), the desired luminance level from the display surfaces (cd/m² or Nits), and ambient lighting conditions at the location of the display panel array. For example, a 1 m² display surface will require a projector output of about 1500 lumens in order to produce a display luminance of about 460 Nits.

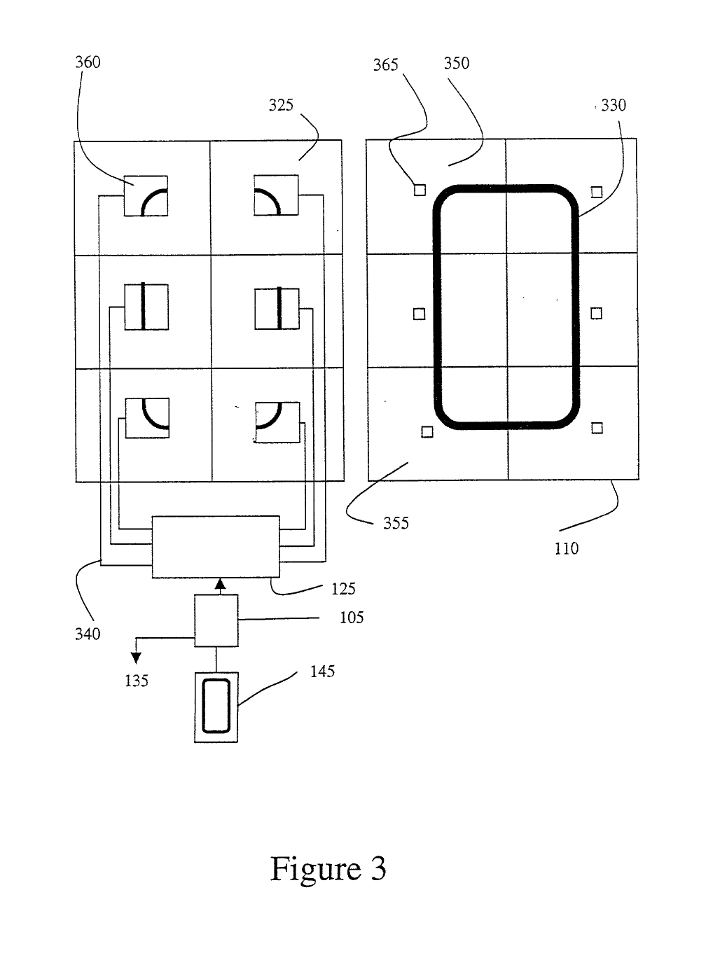

FIG. 3 provides a front and back view of fiber optic display panel array 200. Illustrated is a display front side 355, a display back side 325, an array of fiber enclosures 360, a fiber optic panel array 350, a display surface 320, a projected image 330, and an array of optical fiber bundles 340. Also shown are input matrix 125, image projector 105, image source 145, and an array of sensors 365.

In operation, image source 145 generates and transfers an analog or digital electronic signal encompassing projected image 330 to image projector 105. Image projector 105 converts the electronic image to visible light and projects a representation of projected image 330 onto input matrix 125, where it is apportioned according to the number and configuration of optical fiber bundles 340. The image segments are transferred through optical fiber bundles 340 to display backside 325 where fiber bundles 340 are separated into ordered arrays (rows and columns) of display optical fibers 120 (not shown) within fiber enclosures 360. Display optical fibers 120 are distributed as ordered arrays (rows and columns) over fiber optic panel array 350. Each optical fiber 120 terminates at display surface 110 (in rows and columns) where projected image 330 is reconstituted from the ordered image segments.

Fiber optic display panel array 200 can be structurally incorporated into a number of architectural designs. Such architectural displays can be used for dynamic ambient lighting, decorative lighting, or emergency lighting such as direction indicators (exit arrows, for example), and/or can be used to display static or dynamic images for information or advertising on walls, floors, or ceilings, as well as for large-scale video image display.

In one example, sensors 365 may be embedded into display surface 320 as a method for enabling viewer feedback (and thus viewer interaction with the display system). Sensors 365 may also be installed only around the periphery of display surface 320. Sensors 365 may be ultrasonic sensors, infrared sensors, motion sensors, or any other device (or combination of devices) that is capable of detecting viewers in proximity to the display surface. For example, an inexpensive ultrasonic “motion detector” can be embedded directly into the display surface 320. When someone or something approaches the display within the range of the detector, the image can be made to change. Alternatively, some subset of display optical fibers 120 may be configured to accept and transmit light impinging on display surface 320. These “detection” optical fibers are connected to a photosensor array (not shown) that converts changes in light level in proximity to the display surface to electrical signals as is described in U.S. patent application Ser. No. 09/718,744 entitled “Tiled Electro-Optic Interactive Display & Illumination Apparatus and Method for its Assembly and Use,” commonly owned and assigned, herein incorporated by reference in its entirety. As is shown in that application, sensors 365 are connected through a data acquisition system to a controlling computer (not shown) that may change the displayed images depending on viewer interaction. Using this interactive technology, the display system can be used in areas such as training simulators, building security, interactive directional lighting, and gaming environments.

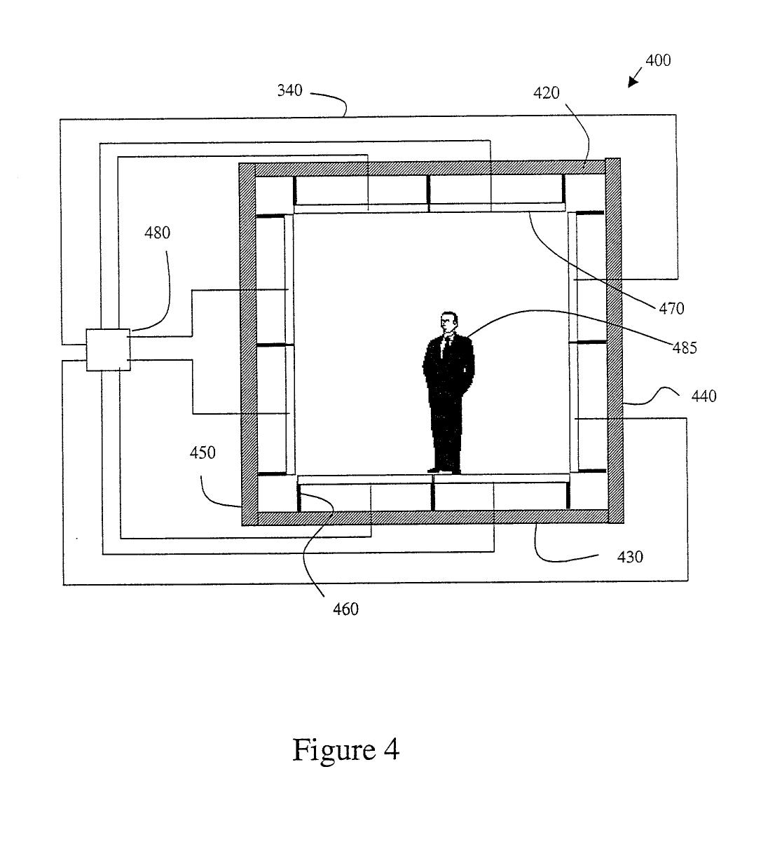

FIG. 4 illustrates an exemplary display room 400 with integrated display panels on floor, walls, and ceiling. Display room 400 includes a ceiling 420, a first wall 440, a second wall 450, and a floor 430. Also included in display room 400 are an array of fiber optic display panels 470, architectural mounts 460, projection system 480, and an array of optical fiber bundles 340. Optical fiber bundles 340 connect image projector system 480 and fiber optic display panels 470 as shown in FIG. 4. Fiber optic display panels 470 are mechanically connected to architectural mounts 460 and architectural mounts 460 are structurally connected to ceiling 420, first wall 440, second wall 450, and floor 430. Additional fiber optic display panels 470 may be mounted on a third and fourth wall (not shown) on both ends of display room 400. Image projection system 480 is comprised of a plurality of image projectors 105, input matrices 125, power sources 135, power line connections 140, image sources 130, and image feed lines 145, as illustrated and described in FIG. 1.

In operation, image projectors 105 receive electronic image content from one or more image sources as shown and described in FIG. 1. The image content is then conveyed through optical fiber bundles 340 to fiber optic display panels 470 where it is displayed in room 400 for viewing.

There are essentially an unlimited number of potential applications for display room 400. Examples could include, but are not limited to the following. Display room 400 may serve as a three-dimensional simulator allowing the viewer or user 485 to feel as if he or she is walking on the moon or in any natural setting while dynamic meteorites streak across the sky or spacecraft lift-off or land in real time. Display room 400 may serve as a gaming environment, utilizing viewer or user input to provide images and feedback. Display room 400 could be a hallway with images of fine art displayed on the walls, with software and/or user interaction controlling the selection of images and the frequency at which images are changed. Display room 400 could serve as a pilot training simulator, displaying real-time images of the flight deck, the sky, and ground, and displaying real-time image updates as the pilot adjusts direction, altitude, and attitude.

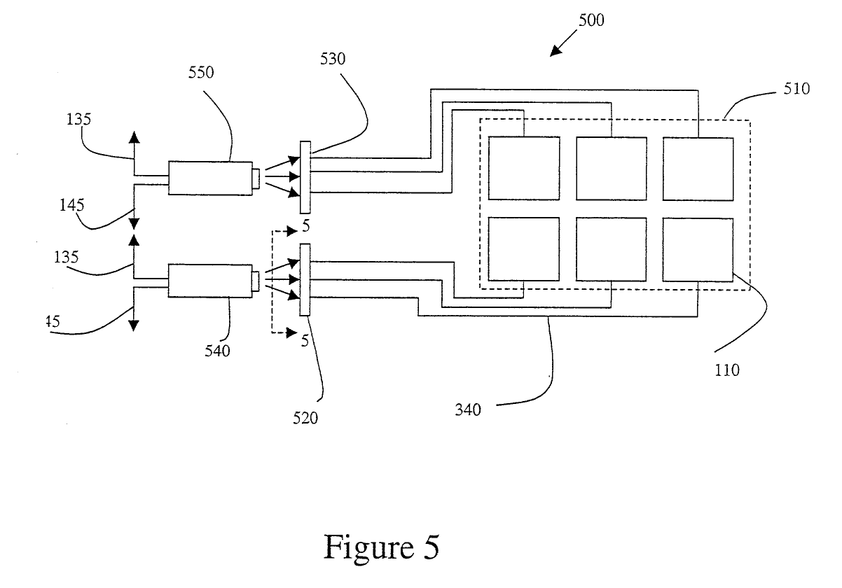

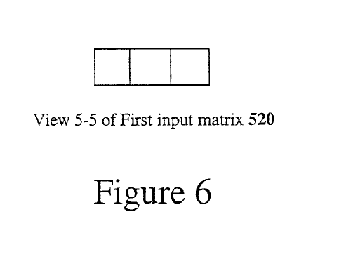

Another example refers to FIG. 5 and FIG. 6, a two-projector system 500 in which two image projectors provide images to a 2×3 fiber optic display panel arrangement. The system includes first image projector 540 and second image projector 550 optically connected to first input matrix 520 and second input matrix 530, respectively. Optical fiber bundles 340 optically connect input matrix 520 and input matrix 530 to an array of display surfaces 110, which comprise display array 510.

In operation, image projectors 540 and 550 each provide image content to half of the display surfaces 110 in display array 510, as shown in FIG. 5. View 5-5 in FIG. 6 shows the first input matrix 520 segmented into three sections, each providing a portion of the projected image to three separate display surfaces 110.

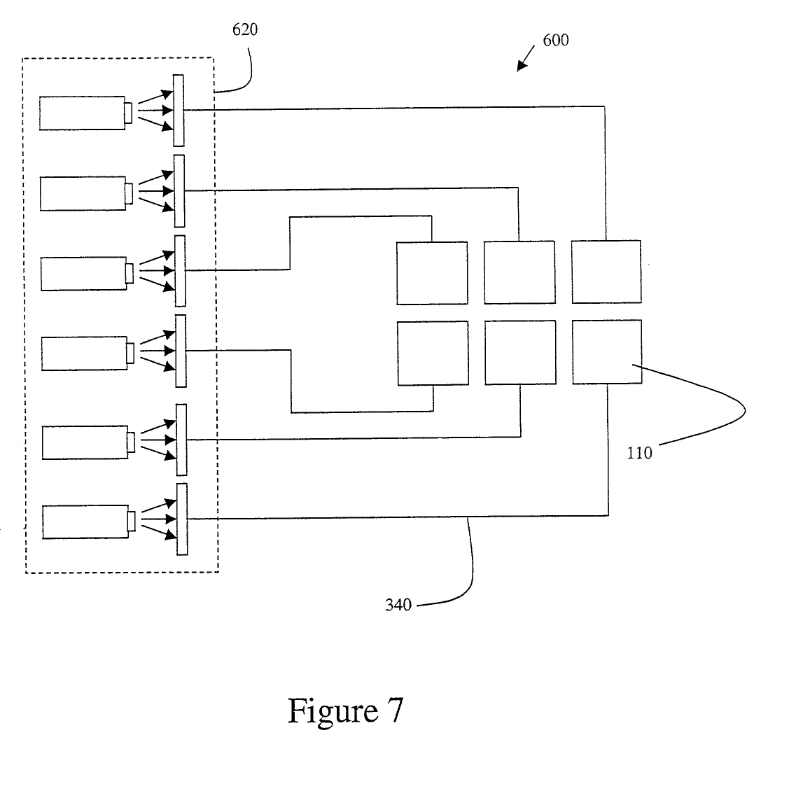

FIG. 7 illustrates a further example of a six-projector system 600 in which six image projectors provide image content to a 2×3 fiber optic display panel arrangement in which each display panel has a dedicated image projector. The system includes an image projection system array 620, an array of display surfaces 110, and an array of optical fiber bundles 340. Image projection system array 620 is comprised of six image projection systems 480. As shown and described in FIG. 1 and FIG. 4, image projection system 480 includes image projectors 105, input matrices 125, power sources 135, power line connections 140, image sources 130, and image feed lines 145.

In operation, each image projector in image projection system array 620 provides image content to each display surface 110, as shown in FIG. 7. Each display surface 110 may display a distinct and unique image or lighting scheme, or all the images on display surfaces 110 may be combined to form a single large image across the entire display array.

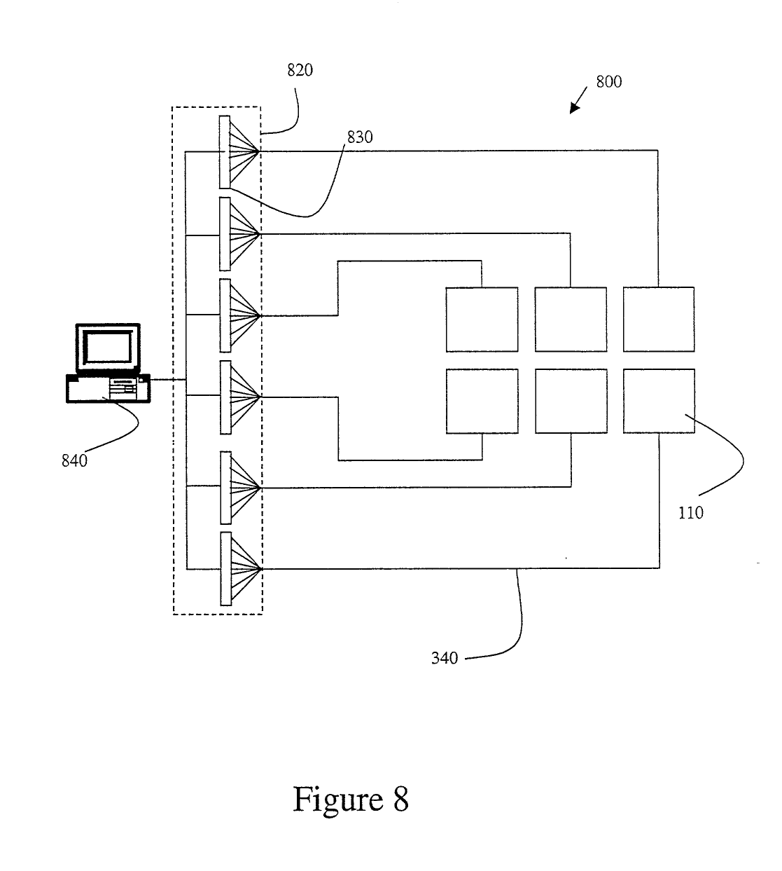

FIG. 8 illustrates a further example, a micro-display system 800 in which six micro-displays provide the image content for a 2×3 fiber optic display panel arrangement. Each display surface 110 communicates via optical fiber bundles 340 with a dedicated micro-display 830. System 800 includes a micro-display array 820 of dedicated micro-displays 830, an array of display surfaces 110, an array of optical fiber bundles 340, and a controlling computer 840.

Micro-display array 820 is comprised of dedicated micro-displays 830. Each micro-display is a miniature spatial light modulator (“SLM”), commonly available as an off-the-shelf product. Each micro-display is electrically connected to controlling computer 840, which provides a digital image to each micro-display. From this digital data stream, micro-displays 830 generate optical images that are conveyed into optical fiber bundles 340, which communicate directly with each micro-display. Light is transmitted through optical fiber bundles 340 to display surfaces 110. Because the micro-display 830 is a relatively low-power device, the length of optical fiber bundles 340 is generally kept as short as possible. The micro-display embodiment obviates the need for image projector system 480 and allows an image to be transmitted more directly to the display panels 110. Micro-displays 830 may be controlled to provide a single large image, or multiple smaller images. Additionally, micro-displays 830 can each be configured to drive one or more display panels.

The benefits and advantages of this invention over state-of-the-art display technology include one or more of the following. One advantage of this invention is that it is configurable to standardized architectural panel sizes and mountable on floors, ceilings, and walls. A second advantage of this invention is that it provides seamless displays. A third advantage of this invention is that it can be configured to be interactive with a viewer or user. A fourth advantage of this invention is that the display panels do not require electrical power on or near the display surfaces. A fifth advantage of this invention is that it is lightweight, submersible, and characterized by low power consumption and concomitant low heat generation which are critical for architectural deployment.

The invention claimed is:

1. An architectural display apparatus, comprising:
a plurality of display panels, each panel including a display surface and an array of display optical fibers;
a projector capable of projecting one or more images;
an input matrix optically connected to each array of display optical fibers and positioned such that the input matrix receives an image from the projector, apportions the image into image segments, and distributes the apportioned image segments to the arrays of display optical fibers; and
a support structure sized and positioned to maintain the plurality of display panels in a contour and shape to match a contour and shape of an existing environment.

2. The apparatus of claim 1 wherein at least one of the display panels also includes a sensor array.

3. The apparatus of claim 2 wherein the sensor array comprises at least one of an ultrasonic sensor, an infrared sensor, a light-sensitive transducer, and a motion detector.

4. The apparatus of claim 1 wherein the support structure comprises a plurality of architectural mounts, and the architectural mounts are structurally connected to the existing environment.

5. The apparatus of claim 1 wherein the display optical fibers are arranged in an ordered array.

6. An architectural display apparatus, comprising:
a plurality of display panels, each panel including a display surface and an array of display optical fibers;
a plurality of projectors capable of projecting one or more images;
a plurality of input matrices optically connected to each array of display optical fibers, the matrices positioned such that each input matrix receives an image from one of the projectors, apportions the image into image segments, and distributes the image segments to one of the arrays of display optical fibers; and
a support structure sized and positioned to maintain the plurality of display panels in a contour and shape to match a contour and shape of an existing environment.

7. The apparatus of claim 6 wherein at least one of the display panels also includes a sensor array.

8. The apparatus of claim 7 wherein the sensor array comprises at least one of an ultrasonic sensor, an infrared sensor, a light-sensitive transducer, and a motion detector.

9. The apparatus of claim 6 wherein the support structure comprises a plurality of architectural mounts, and the architectural mounts are structurally connected to the existing environment.

10. The apparatus of claim 6 wherein the display optical fibers are arranged in an ordered array.
